(19) United States
(12) Patent Application Publication
(10) Pub. No.: US 2019/0379127 A1
(43) Pub. Date: Dec. 12, 2019

(54) Terminal Antenna and Terminal

(71) Applicant: HUAWEI TECHNOLOGIES CO., LTD., Shenzhen (CN)

(72) Inventors: Su XU, Shenzhen (CN); Huailin WEN, Ottawa (CA)

(21) Appl. No.: 16/548,626

(22) Filed: Aug. 22, 2019

Related U.S. Application Data
(63) Continuation of application No. PCT/CN2018/075959, filed on Feb. 9, 2018.

(30) Foreign Application Priority Data
Feb. 23, 2017 (CN) 201710101960.0

(51) Int. Cl. H01Q 15/00; H01Q 9/04; H01Q 1/52; H01Q 1/22; H01Q 1/38

(52) U.S. Cl. CPC H01Q 15/006; H01Q 9/0407; H01Q 1/38; H01Q 1/22; H01Q 1/528

(57) ABSTRACT

This application discloses a terminal antenna and a terminal for wireless communications. The terminal antenna includes: a grounding plate, an antenna support, and an antenna radiation structure. The grounding plate is connected to the antenna support. The antenna radiation structure is separately connected to the grounding plate and the antenna support. The antenna support has anisotropy.

### CROSS-REFERENCE TO RELATED APPLICATIONS

This application is a continuation of International Application No. PCT/CN2018/075959, filed on Feb. 9, 2018, which claims priority to Chinese Patent Application No. 201710101960.0, filed on Feb. 23, 2017. The disclosures of the aforementioned applications are hereby incorporated by reference in their entireties.

### TECHNICAL FIELD

This application relates to the field of wireless communications technologies, and in particular, to a terminal antenna and a terminal.

### BACKGROUND

A terminal antenna is an apparatus for transmitting and receiving signals, and the terminal antenna is an indispensable part of a terminal. Bandwidth and efficiency of the terminal antenna directly affect communication quality of the terminal. With rapid development of wireless communications technologies, people impose a higher requirement on the bandwidth and efficiency of the terminal antenna.

In related technologies, the terminal antenna mainly includes a grounding plate, an antenna support, and an antenna radiation structure. The antenna support is isotropic, that is, components of a constitutive parameter of the antenna support (the constitutive parameter is a parameter that is used to reflect nature of a material, such as a relative permittivity) in a specific direction is numerically identical to those in any other direction.

In a process of implementing this application, the inventor finds that the prior art has at least the following problems:

The bandwidth and efficiency of the terminal antenna are positively correlated with a size of the terminal antenna. To ensure that the bandwidth and efficiency of the terminal antenna meet a design requirement, the size of the terminal antenna is usually increased. Therefore, a size of an existing terminal antenna is relatively large, limiting further miniaturization of the terminal, and limiting a structural design or a size design of the terminal, and so on.

### SUMMARY

To resolve a problem that a structural design of a terminal is limited because a size of a terminal antenna in a related technology is relatively large, an embodiment of the present invention provides a terminal antenna and a terminal. Technical solutions are as follows.

According to a first aspect, a terminal antenna is provided. The terminal antenna includes: a grounding plate, an antenna support, and an antenna radiation structure, where the grounding plate is connected to the antenna support, the antenna radiation structure is separately connected to the grounding plate and the antenna support, and the antenna support has anisotropy.

The antenna support has anisotropy, that is, components of a constitutive parameter of the antenna support in a specific direction are numerically different from those in any other direction. In this way, an electromagnetic wave can radiate in different directions, and the antenna support assists in radiation. Therefore, according to the solution provided in this application, when the size of the terminal antenna is not increased, the bandwidth and efficiency of the terminal antenna can also meet a design requirement.

Optionally, the antenna support includes at least two types of materials whose subwavelengths are periodically arranged, and the at least two types of materials have different constitutive parameters. Because the antenna support having anisotropy is formed by the at least two types of materials with different constitutive parameters, the antenna support assists in radiation. For example, the constitutive parameters may be a permittivity, a magnetic permeability, or the like.

Optionally, the grounding plate is provided with an antenna clearance area.

Arranging the antenna clearance area may further increase bandwidth of the terminal antenna, and improve efficiency of the terminal antenna, so that the bandwidth and efficiency of the terminal antenna can easily meet a design requirement.

Optionally, the antenna support has a planar layer structure, and the constitutive parameter is a relative permittivity. The antenna support is formed by stacking two types of materials, and the two types of materials are arranged at intervals based on a subwavelength period.

The two types of materials are a first material and a second material, a thickness of the first material is not greater than a thickness of the second material, and a sum of the thickness of the first material and the thickness of the second material is less than a half of an electromagnetic wave wavelength corresponding to an operating frequency of the terminal antenna; and a relative permittivity of the first material is greater than a relative permittivity of the second material.

Optionally, a stacking direction of the first material and the second material is perpendicular to a height direction of the grounding plate.

Further, in this embodiment of the present invention, a size of the terminal antenna may be reduced, and a small-sized terminal antenna of a one-eighth wavelength is implemented, thereby reducing occupied space used by the terminal antenna.

Optionally, the grounding plate is not provided with an antenna clearance area.

To reduce a complexity of designing the terminal antenna, the grounding plate may not be provided with an antenna clearance area. The antenna support assists in radiation, so the bandwidth and efficiency of the terminal antenna provided in this embodiment of the present invention can also meet a design requirement without arranging the antenna clearance area.

Optionally, the antenna support is provided with a cavity, and the cavity is configured to dispose other metal components of a terminal.

To enable other metal components to be disposed in the terminal antenna, the antenna support of the terminal antenna may be provided with a cavity, and the metal components in the cavity do not interfere with normal operation of the terminal antenna.

Optionally, a stacking direction of the first material and the second material is parallel to a height direction of the grounding plate. In this embodiment of the present invention, larger bandwidth and higher efficiency are also provided when the antenna clearance area is reduced or even the antenna clearance area is not arranged.

Optionally, the relative permittivity of the first material is greater than or equal to 8, and the relative permittivity of the second material is 1 to 6.

Optionally, the relative permittivity of the second material is 1 to 4.

Optionally, the sum of the thickness of the first material and the thickness of the second material is less than one-fifth of the electromagnetic wave wavelength corresponding to the operating frequency of the terminal antenna.

Optionally, the antenna support is provided with a semiconductor particle, a conductor particle, or an insulator particle. The constitutive parameter of a material of the antenna support is adjusted by using the semiconductor particle, the conductor particle, or the insulator particle. Optionally, the antenna support has a columnar array structure, a hole-shaped array structure, a ring array structure, or a curved surface layer structure.

Optionally, the terminal antenna is a single-band planar inverted F antenna, a multi-band planar inverted F antenna, a monopole antenna, or a patch antenna.

The terminal antenna provided in this embodiment of the present invention is applicable to different frequency bands, such as a low frequency 900 MHz, a dual frequency (900 MHz and 1800 MHz), and a high frequency (such as 3500 MHz, 4500 MHz, or 4650 MHz).

According to a second aspect, a terminal is provided, where the terminal includes an antenna system, and the antenna system includes the terminal antenna according to the first aspect.

An antenna support of the terminal antenna included in the antenna system has anisotropy, that is, components of a constitutive parameter of the antenna support in a specific direction are numerically different from those in any other direction. In this way, an electromagnetic wave can radiate in different directions, and the antenna support assists in radiation. Therefore, when a size of the terminal antenna is not increased, bandwidth and efficiency of the terminal antenna can also meet the design requirement, thereby ensuring communication quality of the terminal. Further, the size of the terminal antenna may be reduced, and when a size of the terminal is not increased, an arrangement requirement of the terminal antenna can be met, and an arrangement requirement of components such as a battery or a radiant panel can also be met. In addition, an antenna clearance area may not be arranged, thereby reducing complexity of designing the terminal antenna, and further reducing complexity of designing the terminal.

Optionally, the antenna system further includes a printed circuit board PCB connected to the terminal antenna.

The technical solutions provided in the embodiments of the present invention bring the following beneficial effects:

The antenna support of the terminal antenna has anisotropy, that is, components of the constitutive parameter of the antenna support in a specific direction are different from those in any other direction. In this way, the electromagnetic wave can radiate in different directions, and the antenna support assists in radiation. Therefore, when the size of the terminal antenna is not increased, the bandwidth and efficiency of the terminal antenna can also meet the design requirement.

### BRIEF DESCRIPTION OF DRAWINGS

FIG. 1 is a schematic structural diagram of a terminal antenna in the related art;

FIG. 2-1 is a schematic structural diagram of a terminal antenna according to an embodiment of the present invention;

FIG. 2-2 is a schematic structural diagram of a terminal antenna according to an embodiment of the present invention;

FIG. 2-3 is a top view of a small-sized dual-band PIFA according to an embodiment of the present invention;

FIG. 2-4 is a curve diagram of efficiency and a band frequency of the PIFA shown in FIG. 2-3;

FIG. 2-5 is a curve diagram of efficiency and a band frequency of another small-sized dual-band PIFA according to an embodiment of the present invention;

FIG. 2-6 is a curve diagram of efficiency and a band frequency of still another small-sized dual-band PIFA according to an embodiment of the present invention;

FIG. 2-7 is a schematic diagram of an antenna support with a hole-shaped array structure according to an embodiment of the present invention;

FIG. 2-8 is a schematic diagram of an antenna support with a columnar array structure according to an embodiment of the present invention;

FIG. 2-9 is a schematic diagram of an antenna support with a curved surface layer structure according to an embodiment of the present invention;

FIG. 3-1 is a schematic structural diagram of another terminal antenna according to an embodiment of the present invention;

FIG. 3-2 is a schematic structural diagram of a terminal antenna according to an embodiment of the present invention;

FIG. 3-3 is a schematic structural diagram of a dual-band terminal antenna according to an embodiment of the present invention;

FIG. 3-4 is a curve diagram of efficiency and a band frequency of the terminal antenna shown in FIG. 3-3;

FIG. 3-5 is a top view of a low-frequency terminal antenna according to an embodiment of the present invention;

FIG. 3-6 is a curve diagram of efficiency and a band frequency of the terminal antenna shown in FIG. 3-5;

FIG. 3-7 is a top view of another dual-band terminal antenna according to an embodiment of the present invention;

FIG. 3-8 is a curve diagram of efficiency and a band frequency of the terminal antenna shown in FIG. 3-7;

FIG. 3-9 is a top view of another terminal antenna according to an embodiment of the present invention;

FIG. 3-10 is a side view of the terminal antenna shown in FIG. 3-9; and

FIG. 3-11 is a curve diagram of efficiency and a band frequency of the terminal antenna shown in FIG. 3-10.

### DESCRIPTION OF EMBODIMENTS

To make the objectives, technical solutions, and advantages of this application clearer, the following further describes the implementations of this application in detail with reference to the accompanying drawings.

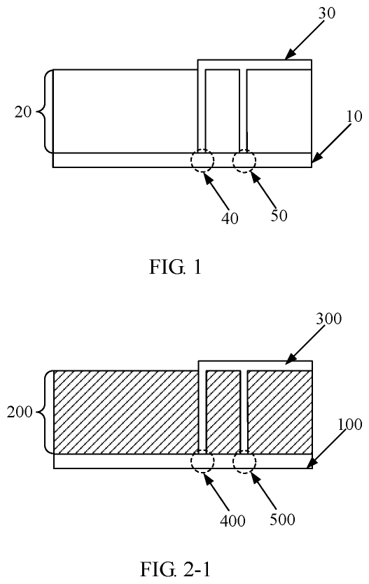

FIG. 1 is a schematic structural diagram of a terminal antenna in the related art. The terminal antenna includes a grounding plate 10, an antenna support 20, and an antenna radiation structure 30. The antenna support 20 is isotropic, that is, components of a constitutive parameter of the antenna support 20 in a specific direction are numerically identical to those in any other direction. In FIG. 1, 40 represents a ground point, and 50 represents a feed point (a feed point is a connection point between a terminal antenna and a feeder). The constitutive parameter is a parameter used to reflect nature of a material. For example, the constitutive parameter may be a permittivity, a magnetic permeability, or the like. Bandwidth and efficiency of the terminal antenna directly affect communication quality of a terminal (such as a mobile phone). Because the bandwidth and efficiency of the terminal antenna are positively correlated with a size of the terminal antenna, to ensure that the bandwidth and efficiency of the terminal antenna meet a design requirement, and to enable the terminal antenna to meet a performance requirement, the size of the terminal antenna is generally increased, and a large-sized terminal antenna occupies relatively large space. Because most of space in the terminal is occupied by components such as a battery and a radiant panel, only small space is reserved for the large-sized terminal antenna, thereby affecting an arrangement of the terminal antenna. If the space reserved for the large-sized terminal antennas is increased, the arrangement of components such as the battery and the radiant panel may be affected. If the size of the terminal is increased to meet an arrangement requirement of the terminal antenna and an arrangement requirement of the components such as the battery and the radiant panel, a requirement of a user for using a small-sized terminal cannot be met.

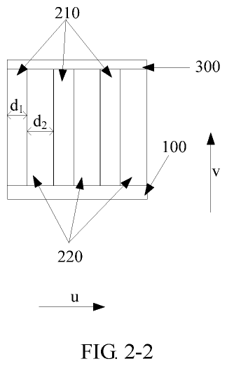

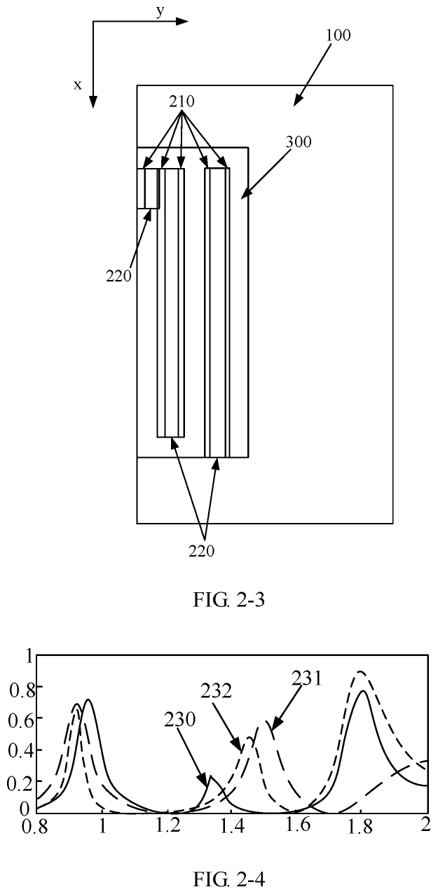

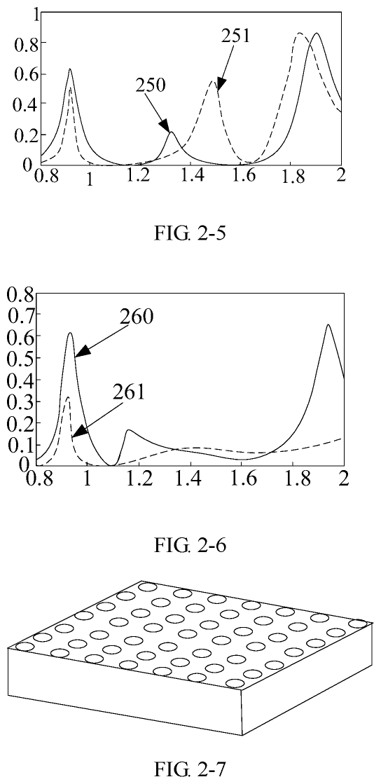

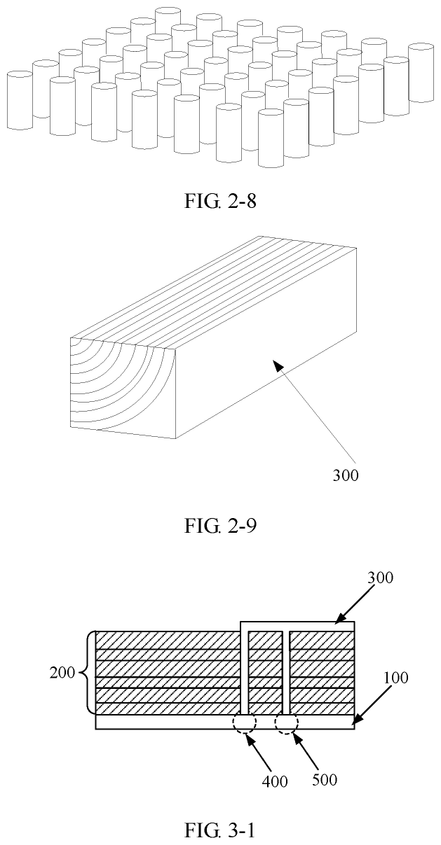

An embodiment of the present invention provides a terminal antenna. As shown in FIG. 2-1, the terminal antenna includes a grounding plate 100, an antenna support 200, and an antenna radiation structure 300. The grounding plate 100 is connected to the antenna support 200, and the antenna radiation structure 300 is separately connected to the grounding plate 100 and the antenna support 200. The antenna support 200 has anisotropy. The antenna support has anisotropy, that is, components of a constitutive parameter of the antenna support in a specific direction are different from those in any other direction. In this way, an electromagnetic wave can radiate in different directions, and the antenna support assists in radiation. Therefore, according to the solution in this application, when a size of the terminal antenna is not increased, bandwidth and efficiency (that is, radiation efficiency) of the terminal antenna can also meet a design requirement. In FIG. 2-1, 400 represents a ground point, and 500 represents a feed point.

Optionally, the antenna support includes at least two types of materials whose subwavelengths are periodically arranged, and the at least two types of materials have different constitutive parameters. A subwavelength refers to a distance range that is less than a medium wavelength corresponding to an operating frequency of the terminal antenna. The medium wavelength refers to a wavelength of an electromagnetic wave in any medium. In this embodiment of the present invention, a sum of thicknesses of the at least two types of materials is within a subwavelength range. For example, the antenna support includes three types of materials whose subwavelengths are periodically arranged. The three types of materials are respectively a material A, a material B, and a material C, and the material A, material B, and material C have different constitutive parameters.

To further increase the bandwidth and efficiency of the terminal antenna, the grounding plate may be provided with an antenna clearance area. The antenna clearance area refers to an area, where a metallic ground is not arranged, of the grounding plate. Because the electromagnetic wave requires relatively large space in a radiation process, the antenna clearance area is arranged on the grounding plate. Therefore the terminal antenna may have a larger bandwidth and higher efficiency, and the bandwidth and efficiency of the terminal antenna can easily meet the design requirement.

For example, the antenna support may have a planar layer structure, and the constitutive parameter may be a relative permittivity. The terminal antenna in this embodiment of the present invention is described by using an example in which the antenna support has the planar layer structure and the constitutive parameter is the relative permittivity. The relative permittivity indicates a degree of polarization of a dielectric, and a relative permittivity of a medium is a ratio of a permittivity of the medium to a free-space permittivity.

FIG. 2-2 is a side view of a terminal antenna with a planar layer structure. Referring to FIG. 2-2, the antenna support is formed by stacking two types of materials. The two types of materials are arranged at intervals based on a subwavelength period, and the subwavelength is a sum of thicknesses of the two types of materials. The two types of materials are a first material 210 and a second material 220. A thickness d₁ of the first material 210 is not greater than a thickness d₂ of the second material 220, that is, the thickness of the first material 210 may be less than the thickness of the second material 220, or may be equal to the thickness of the second material 220. A sum of the thickness d₁ of the first material 210 and the thickness d₂ of the second material 220 is less than a half of an electromagnetic wave wavelength corresponding to an operating frequency of the terminal antenna. Further, the sum of the thickness d₁ of the first material 210 and the thickness d₂ of the second material 220 is less than one-fifth of the electromagnetic wave wavelength corresponding to the operating frequency of the terminal antenna. In FIG. 2-2, 100 represents a grounding plate, and 300 represents an antenna radiation structure.

Referring to FIG. 2-2, a relative permittivity ε₁ of the first material 210 is greater than a relative permittivity ε₂ of the second material 220. Optionally, the relative permittivity ε₁ of the first material is greater than or equal to 8, and the relative permittivity ε₂ of the second material is 1 to 6. Further, the relative permittivity ε₂ of the second material is 1 to 4.

According to the relative permittivity of the first material and the relative permittivity of the second material, an equivalent relative permittivity of the antenna support in each direction may be obtained. Specifically, the equivalent relative permittivity of the antenna support in each direction may be determined according to a formula for calculating the equivalent relative permittivity. The formula for calculating the equivalent relative permittivity is as follows:

$$\{ \begin{matrix}{ɛ}_{⊥} = ( {ɛ}_{1} {ɛ}_{2} ) \text{/} ( f {ɛ}_{2} + ( 1 - f ) {ɛ}_{1} ) \\ {ɛ}_{‖} = f {ɛ}_{1} + ( 1 - f ) {ɛ}_{2} \\ f = {d}_{1} \text{/} ( {d}_{1} + {d}_{2} )\end{matrix}$$

Herein, ε₁ represents the relative permittivity of the first material, ε₂ represents the relative permittivity of the second material, ε_{⊥} represents the equivalent relative permittivity of the antenna support in a first direction, ε_{∥} represents the equivalent relative permittivity of the antenna support in a second direction (the second direction is perpendicular to the first direction), d₁ represents the thickness of the first material, d₂ represents the thickness of the second material, f represents a ratio of d₁ to (d₁+d₂), and (d₁+d₂)<<min(λ₁, λ₂), where λ₁ represents a wavelength of the first material, λ₂ represents a wavelength of the second material, min(λ₁, λ₂) represents a minimum value of λ₁ and λ₂ and (d₁+d₂)<<min(λ₁, λ₂) represents that the sum of the thickness of the first material and the thickness of the second material is far less than the minimum value.

It should be additionally noted that when the constitutive parameter is a magnetic permeability, a magnetic permeability of the antenna support in each direction may also be determined by referring to the formula for calculating the equivalent relative permittivity.

Referring to FIG. 2-2, a stacking direction (for example, the direction indicated by u in FIG. 2-2) of the first material 210 and the second material 220 is perpendicular to a height direction (for example, the direction indicated by v in FIG. 2-2) of the grounding plate 100.

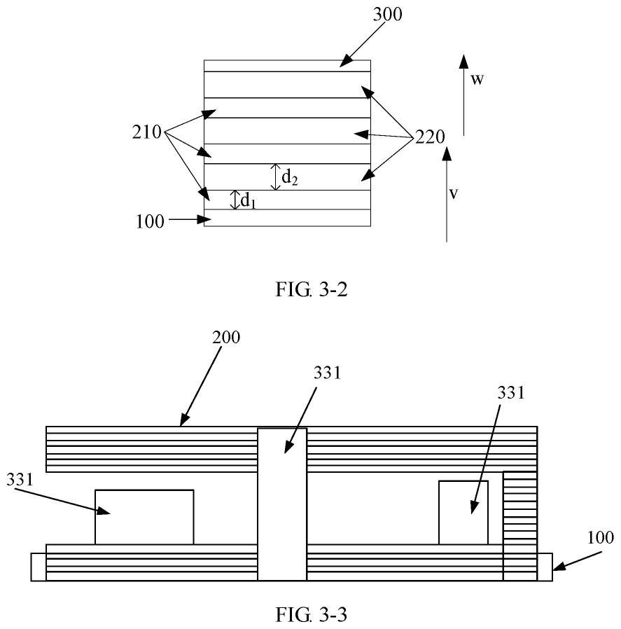

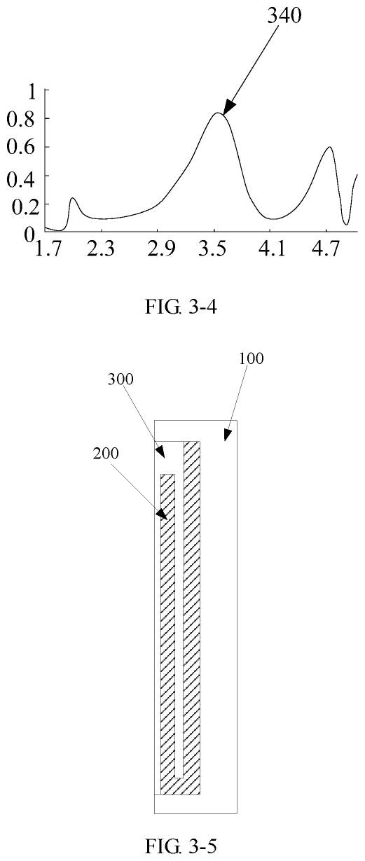

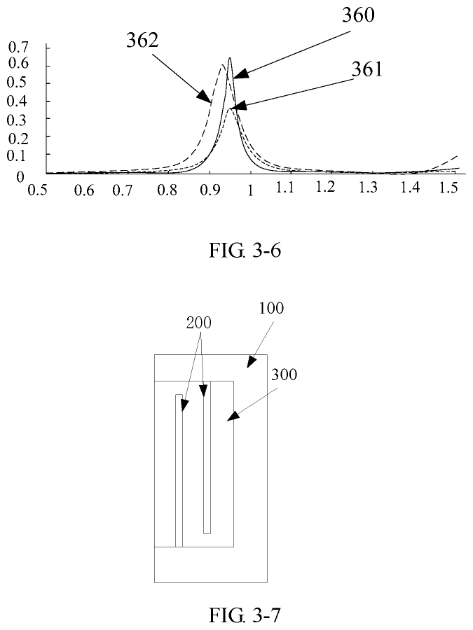

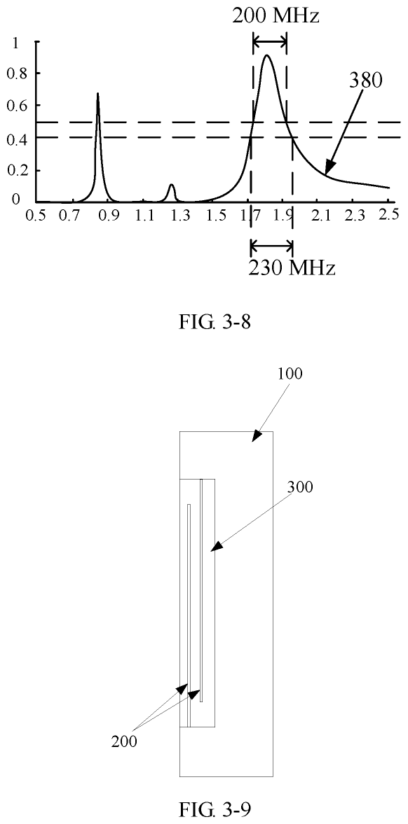

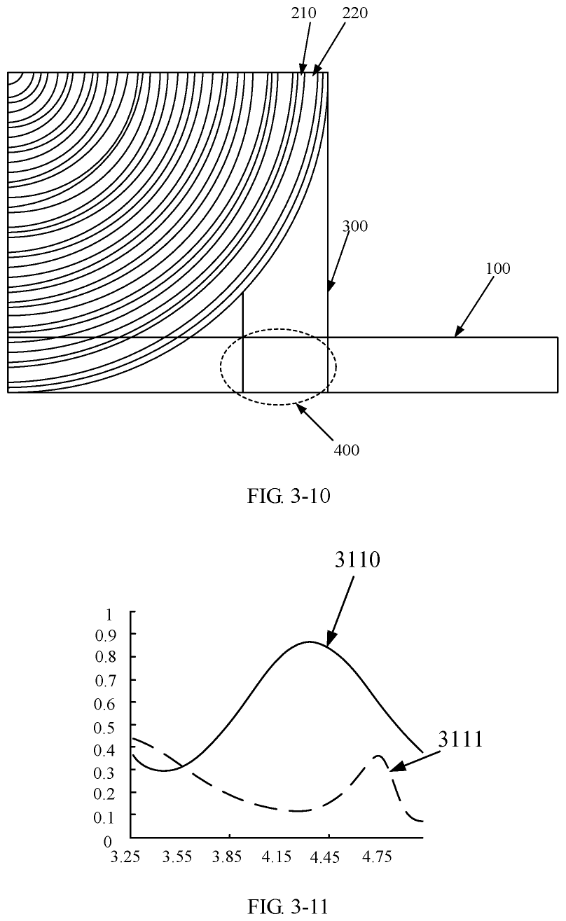

For example, FIG. 2-3 is a top view of a small-sized dual-band (900 MHz (megahertz) and 1800 MHz) planar inverted F antenna (English: Planar Inverted F Antenna, PIFA for short). The PIFA is an S-type PIFA, and a size of the PIFA is 21 mm (millimeters)*7 mm*6 mm, where a length of the PIFA is 21 mm, a width of the PIFA is 7 mm, a height of the PIFA is 6 mm, and a distance of the PIFA above the ground is 6 mm. A material of an antenna support of the PIFA is a ceramic plastic mixed coating, and has an equivalent relative permittivity in each direction. Specifically, the antenna support of the PIFA is formed by stacking microwave dielectric ceramics (that is, a first material) 210 and microwave dielectric plastic boards (that is, a second material) 220. A thickness ratio of the microwave dielectric ceramics to the microwave dielectric plastic boards is 3:5. A relative permittivity of the microwave dielectric ceramics is 106, and a relative permittivity of the microwave dielectric plastic boards is 2.5. According to the foregoing formula for calculating the equivalent relative permittivity, an equivalent relative permittivity of the antenna support of the PIFA in a width direction (for example, the direction indicated by y in FIG. 2-3) is approximately equal to 4, and an equivalent relative permittivity of the antenna support of the PIFA in a length direction (for example, the direction indicated by x in FIG. 2-3) is approximately equal to 40. In FIG. 2-3, 100 represents a grounding plate, and 300 represents an antenna radiation structure.

FIG. 2-4 is a curve diagram of efficiency and a band frequency of the PIFA 230, a terminal antenna 231, and a terminal antenna 232. In FIG. 2-4, a horizontal coordinate indicates the frequency, a unit is GHz (gigahertz), and a vertical coordinate indicates the efficiency. An antenna support of the terminal antenna 231 is isotropic, a material of the antenna support is glass fiber epoxy resin, a relative permittivity of the material is about 4.4, a flame-retardant level of the material is FR4, and a size of the terminal antenna 231 is 30 mm*10 mm*6 mm. An antenna support of the terminal antenna 232 is isotropic, a material of the antenna support is microwave dielectric ceramics, a relative permittivity of the materials is 18, and a size of the terminal antenna 232 is 21 mm*7 mm*6 mm.

Data in Table 1 may be obtained based on FIG. 2-4 and the size of each terminal antenna. The low-frequency band in Table 1 is a low-frequency band corresponding to efficiency of 50% in FIG. 2-4. Referring to FIG. 2-4, the low-frequency band corresponding to the efficiency of 50% of the PIFA 230 is (930-990) MHz. It can be learned from FIG. 2-4 and Table 1 that comparing the PIFA 230 with the terminal antenna 231, a low-frequency bandwidth of the PIFA 230 is equal to a low-frequency bandwidth of the terminal antenna 231, but occupied space of the PIFA 230 is less than occupied space of the terminal antenna 231. The occupied space of the PIFA 230 is approximately 50% of the occupied space of the terminal antenna 231. Comparing the PIFA 230 with the terminal antenna 232, the occupied space of the PIFA 230 is equal to occupied space of the terminal antenna 232, but the low-frequency bandwidth of the PIFA 230 is greater than a low-frequency bandwidth of the terminal antenna 232, and the low-frequency bandwidth of the terminal antenna 232 is approximately 33% of the low-frequency bandwidth of the PIFA 230. Therefore, when relatively small occupied space is used, the PIFA 230 provided in this embodiment of the present invention may keep the low-frequency bandwidth (60 MHz) of 900 MHz unchanged.

TABLE 1

| | Low-frequency | Low-frequency | Occupied |
|---|---|---|---|
| Type | band | bandwidth | space |
| Terminal antenna 231 | (890-950) MHz | 60 MHz | 100% |
| Terminal antenna 232 | (910-930) MHz | 20 MHz | 49% |
| PIFA 230 | (930-990) MHz | 60 MHz | 49% |

An embodiment of the present invention further provides another small-sized dual-band (900 MHz and 1800 MHz) PIFA. For a top view of the PIFA, refer to FIG. 2-3. A size of the PIFA is 21 mm*5 mm*6 mm, and a distance of the PIFA above the ground is 6 mm. A material of an antenna support of the PIFA is a ceramic plastic mixed coating, and has an equivalent relative permittivity in each direction. Specifically, the antenna support of the PIFA is formed by stacking microwave dielectric ceramics (that is, a first material) and microwave dielectric plastic boards (that is, a second material). A thickness ratio of the microwave dielectric ceramics to the microwave dielectric plastic boards is 3:7. A relative permittivity of the microwave dielectric ceramics is 133, and a relative permittivity of the microwave dielectric plastic boards is 2.5. According to the foregoing formula for calculating the equivalent relative permittivity, an equivalent relative permittivity of the antenna support of the PIFA in a width direction (for example, the direction indicated by y in FIG. 2-3) may be approximately equal to 3.6, and an equivalent relative permittivity of the antenna support of the PIFA in a length direction (for example, the direction indicated by x in FIG. 2-3) is approximately equal to 40. FIG. 2-5 is a curve diagram of efficiency and a band frequency of the PIFA 250 and a terminal antenna 251. In FIG. 2-5, a horizontal coordinate indicates the frequency, a unit is GHz, and a vertical coordinate indicates the efficiency. An antenna support of the terminal antenna 251 is isotropic, a material of the antenna support is microwave dielectric ceramics, a relative permittivity of the material is 18, and a size of the terminal antenna 251 is 21 mm*5 mm*6 mm. Data in Table 2 may be obtained according to FIG. 2-5 and the size of each terminal antenna. The low-frequency band in Table 2 is a low-frequency band corresponding to efficiency of 50% in FIG. 2-5. It can be learned from FIG. 2-5 and Table 2 that when relatively small occupied space is used, the PIFA 250 provided in this embodiment of the present invention may implement 900 MHz low-frequency radiation, and a low-frequency bandwidth is 40 MHz. However, the terminal antenna 251 that uses the same size of occupied space cannot implement 900 MHz low-frequency radiation, and a low-frequency bandwidth is 0 MHz.

TABLE 2

| | Low-frequency | Low-frequency | Occupied |
|---|---|---|---|
| Type | band | bandwidth | space |
| Terminal antenna 251 | | 0 MHz | 35% |
| PIFA 250 | (900-940) MHz | 40 MHz | 35% |

An embodiment of the present invention further provides still another small-sized dual-band (900 MHz and 1800 MHz) PIFA. For a top view of the PIFA, refer to FIG. 2-3. A size of the PIFA is 15 mm*7 mm*6 mm, and a distance of the PIFA above the ground is 6 mm. A material of an antenna support of the PIFA is a ceramic plastic mixed coating, and has an equivalent relative permittivity in each direction. Specifically, the antenna support of the PIFA is formed by stacking microwave dielectric ceramics (that is, a first material) and microwave dielectric plastic boards (that is, a second material). A thickness ratio of the microwave dielectric ceramics to the microwave dielectric plastic boards is 1:1. A relative permittivity of the microwave dielectric ceramics is 170, and a relative permittivity of the microwave dielectric plastic board is 2.5. According to the foregoing formula for calculating the equivalent relative permittivity, an equivalent relative permittivity of the antenna support of the PIFA in a width direction (for example, the direction indicated by y in FIG. 2-3) may be approximately equal to 5, and an equivalent relative permittivity of the antenna support of the PIFA in a length direction (for example, the direction indicated by x in FIG. 2-3) is approximately equal to 85. FIG. 2-6 is a curve diagram of efficiency and a band frequency of the PIFA 260 and a terminal antenna 261. In FIG. 2-6, a horizontal coordinate indicates the frequency, a unit is GHz, and a vertical coordinate indicates the efficiency. An antenna support of the terminal antenna 261 is isotropic, a material of the antenna support is microwave dielectric ceramics, and a relative permittivity of the material is 28. A size of the terminal antenna 261 is 15 mm*7 mm*6 mm. Data in Table 3 may be obtained according to FIG. 2-6 and the size of each terminal antenna. The low-frequency band in Table 3 is a low-frequency band corresponding to efficiency of 50% in FIG. 2-6. It can be learned from FIG. 2-6 and Table 3 that when relatively small occupied space is used, the PIFA 260 provided in this embodiment of the present invention may implement 900 MHz low-frequency radiation, and a low-frequency bandwidth is 40 MHz. However, the terminal antenna 261 that uses the same size of occupied space cannot implement 900 MHz low-frequency radiation, a low-frequency bandwidth is 0 MHz, and the efficiency is always less than 50%.

TABLE 3

| | Low-frequency | Low-frequency | Occupied |
|---|---|---|---|
| Type | band | bandwidth | space |
| Terminal antenna 261 | | 0 MHz | 35% |
| PIFA 260 | (910-950) MHz | 40 MHz | 35% |

It can be learned from the foregoing description that when the size of the terminal antenna provided in this embodiment of the present invention is not increased, the bandwidth and efficiency of the terminal antenna can also meet the design requirement. Further, the size of the terminal antenna may be reduced, and a small-sized terminal antenna of a one-eighth wavelength (the wavelength is a ratio of a wave velocity to an operating frequency of the terminal antenna) is implemented, thereby reducing the occupied space used by the terminal antenna.

In addition, the antenna support in this embodiment of the present invention may further have structures, such as a columnar array structure, a hole-shaped array structure, a curved surface layer structure, or a ring array structure. The structures of the antenna support are not limited in the embodiments of the present invention.

FIG. 2-7 is a schematic diagram of an antenna support with a hole-shaped array structure. When the antenna support is the hole-shaped array structure, air may be used as a material. In addition, at least one material may also be filled into the hole. A type of the material is not limited in the embodiments of the present invention.

FIG. 2-8 is a schematic diagram of an antenna support with a columnar array structure. When the antenna support has the columnar array structure, air may be used as a material. In addition, at least two types of materials may be used to form the columnar array structure.

FIG. 2-9 is a schematic diagram of an antenna support with a curved surface layer structure. The antenna support is formed by stacking at least two types of curved surface materials. In FIG. 2-9, 300 represents an antenna radiation structure.

Optionally, the antenna support may also be provided with a semiconductor particle, a conductor particle, or an insulator particle. A constitutive parameter of a material of the antenna support is adjusted by using the semiconductor particle, the conductor particle, or the insulator particle.

In related technologies, generally, a low-frequency terminal antenna is of a quarter wavelength, and the terminal antenna provided in the embodiments of the present invention has relatively small occupied space. According to the embodiments of the present invention, a small-sized terminal antenna of a one-eighth wavelength can be implemented.

In conclusion, according to the terminal antenna provided in the embodiments of the present invention, the antenna support of the terminal antenna has anisotropy, that is, components of the constitutive parameter of the antenna support in a specific direction are numerically different from those in any other direction. In this way, the electromagnetic wave can radiate in different directions, and the antenna support assists in radiation. Therefore, when the size of the terminal antenna is not increased, the bandwidth and efficiency of the terminal antenna can also meet the design requirement. Further, the size of the terminal antenna may be reduced, a small-sized terminal antenna of a one-eighth wavelength is implemented, and the occupied space used by the terminal antenna is reduced, thereby meeting a requirement of the user for using a small-sized terminal.

An embodiment of the present invention provides another terminal antenna. As shown in FIG. 3-1, the terminal antenna includes a grounding plate 100, an antenna support 200, and an antenna radiation structure 300. The grounding plate 100 is connected to the antenna support 200, and the antenna radiation structure 300 is separately connected to the grounding plate 100 and the antenna support 200. The antenna support 200 has anisotropy. The antenna support has anisotropy, that is, components of a constitutive parameter of the antenna support in a specific direction are numerically different from those in any other direction. In this way, an electromagnetic wave can radiate in different directions, and the antenna support assists in radiation. Therefore, according to the solution in this application, when the size of the terminal antenna is not increased, the bandwidth and efficiency of the terminal antenna can also meet a design requirement. In FIG. 3-1, 400 represents a ground point, and 500 represents a feed point.

Optionally, the antenna support includes at least two types of materials whose subwavelengths are periodically arranged, and the at least two types of materials have different constitutive parameters.

The terminal antenna in this embodiment of the present invention is described by using an example in which the antenna support has a planar layer structure and the constitutive parameter is a relative permittivity. FIG. 3-2 is a side view of a terminal antenna with a planar layer structure. Referring to FIG. 3-2, the antenna support is formed by stacking two types of materials. The two types of materials are arranged at intervals based on a subwavelength period, and the subwavelength is a sum of thicknesses of the two types of materials. The two types of materials are a first material 210 and a second material 220. The thickness d₁ of the first material 210 is not greater than the thickness d₂ of the second material 220. A sum of the thickness d₁ of the first material 210 and the thickness d₂ of the second material 220 is less than a half of an electromagnetic wave wavelength corresponding to an operating frequency of the terminal antenna. Further, the sum of the thickness d₁ of the first material 210 and the thickness d₂ of the second material 220 is less than one-fifth of the electromagnetic wave wavelength corresponding to the operating frequency of the terminal antenna. In FIG. 3-2, 100 represents a grounding plate, and 300 represents an antenna radiation structure.

Referring to FIG. 3-2, a relative permittivity ε₁ of the first material 210 is greater than a relative permittivity ε₂ of the second material 220. Optionally, the relative permittivity ε₁ of the first material is greater than or equal to 8, and the relative permittivity ε₂ of the second material is 1 to 6. Further, the relative permittivity ε₂ of the second material is 1 to 4.

To reduce complexity of designing the terminal antenna, the grounding plate of the terminal antenna provided in this embodiment of the present invention is not provided with an antenna clearance area. The antenna support assists in radiation, so that the bandwidth and efficiency of the terminal antenna provided in this embodiment of the present invention can also meet the design requirement without arranging the antenna clearance area.

Further, to enable other metal components to be disposed in the terminal antenna, the antenna support of the terminal antenna may be provided with a cavity, and the cavity is configured to dispose other metal components of a terminal. These metal components do not interfere with normal operation of the terminal antenna.

Referring to FIG. 3-2, a stacking direction (for example, the direction indicated by w in FIG. 3-2) of the first material 210 and the second material 220 is perpendicular to a height direction (for example, the direction indicated by v in FIG. 3-2) of the grounding plate 100.

For example, FIG. 3-3 is a schematic structural diagram of a dual-band (3500 MHz and 4600 MHz) terminal antenna. The terminal antenna is not provided with an antenna clearance area, and a size of the terminal antenna is 30 mm*2 mm*4 mm. An antenna support of the terminal antenna is formed by stacking microwave dielectric ceramics (that is, a first material) and a polytetrafluorethylene high-frequency board (that is, a second material). A thickness ratio of the microwave dielectric ceramics to the polytetrafluorethylene high-frequency board is 1:1. A relative permittivity of the microwave dielectric ceramics is 60, and a relative permittivity of the polytetrafluoroethylene high-frequency board is approximately 2.5. The antenna support of the terminal antenna is provided with a cavity, and the cavity is configured to dispose other metal components of a terminal. The metal components disposed in the terminal antenna do not affect normal operation of the terminal antenna. In FIG. 3-3, 100 represents the grounding plate, 200 represents the antenna support, and 331 represents the metal components.

FIG. 3-4 is a curve diagram of efficiency and a band frequency of the terminal antenna 340. In FIG. 3-4, a horizontal coordinate is the frequency, a unit is GHz, and a vertical coordinate is the efficiency. Compared with an isotropic terminal antenna that is not provided with an antenna clearance area, the terminal antenna 340 provided in this embodiment of the present invention has a larger bandwidth and higher efficiency.

FIG. 3-5 is a top view of another 900 MHz low-frequency terminal antenna. The terminal antenna is not provided with an antenna clearance area, and a size of the terminal antenna is 40 mm*5 mm*5 mm. An antenna support 200 of the terminal antenna is formed by stacking microwave dielectric ceramics (that is, a first material) and a plastic foam board (that is, a second material). A thickness ratio of the microwave dielectric ceramics to the plastic foam board is 1:1. A relative permittivity of the microwave dielectric ceramics is 16, and a relative permittivity of the plastic foam board is 1.07 to 1.1. In FIG. 3-5, 100 represents a grounding plate, and 300 represents an antenna radiation structure.

FIG. 3-6 is a curve diagram of efficiency and band frequencies of the terminal antenna 360, a terminal antenna 361, and a terminal antenna 362. In FIG. 3-6, a horizontal coordinate indicates the frequency, a unit is GHz, and a vertical coordinate indicates the efficiency. An antenna support of the terminal antenna 361 is isotropic, a relative permittivity of a material of the antenna support is approximately 4.4, and the terminal antenna 361 is not provided with an antenna clearance area. An antenna support of the terminal antenna 362 is isotropic, and the terminal antenna 362 is provided with an antenna clearance area. Band frequency comparison between the terminal antenna 360 and the terminal antenna 361 may be obtained from FIG. 3-6. As shown in Table 4, when operating at 900 MHz simultaneously, compared with the terminal antenna 361, the terminal antenna 360 has a 20 MHz bandwidth that allows efficiency to be greater than 50%, and further has a 30 MHz bandwidth that allows efficiency to be greater than 40%. However, the terminal antenna 361 cannot effectively radiate, and a bandwidth is 0 MHz.

TABLE 4

| | Bandwidth that allows | Bandwidth that allows |
|---|---|---|
| | efficiency to be greater | efficiency to be greater |
| Type | than 50% | than 40% |
| Terminal antenna 361 | 0 MHz | 0 MHz |
| Terminal antenna 360 | 20 MHz | 30 MHz |

For example, FIG. 3-7 is a top view of another dual-band (900 MHz and 1800 MHz) terminal antenna. The terminal antenna is not provided with an antenna clearance area. A length of the terminal antenna is 30 mm, and a width is 11 mm. An antenna support 220 of the terminal antenna is formed by stacking microwave dielectric ceramics (that is, a first material) and a high-frequency dielectric plate (that is, a second material). A thickness ratio of the microwave dielectric ceramics to the high-frequency dielectric plate is 1:1. A relative permittivity of the microwave dielectric ceramics is 30, and a relative permittivity of the high-frequency dielectric plate is 6. In FIG. 3-7, 100 represents a grounding plate, and 300 represents an antenna radiation structure. FIG. 3-8 is a curve diagram of efficiency and a band frequency of the terminal antenna 380. In FIG. 3-8, a horizontal coordinate indicates the frequency, a unit is GHz, and a vertical coordinate indicates the efficiency. As shown in FIG. 3-8, a corresponding bandwidth of the terminal antenna 380 that operates at 900 MHz and 1800 MHz may be obtained. As shown in Table 5, when the terminal antenna 380 operates at 900 MHz, the terminal antenna 380 has a 15 MHz bandwidth that allows efficiency to be greater than 50%, and has a 22 MHz bandwidth that allows efficiency to be greater than 50%. When the terminal antenna 380 operates at 1800 MHz, the terminal antenna 380 has a 200 MHz bandwidth that allows efficiency to be greater than 50%, and has a 230 MHz bandwidth that allows efficiency to be greater than 40%. The 200 MHz bandwidth that allows the efficiency to be greater than 50% and the 230 MHz bandwidth that allows the efficiency to be greater than 40% when the terminal antenna 380 operates at 1800 MHz are identified in FIG. 3-8.

TABLE 5

| | Bandwidth that allows | Bandwidth that allows |
|---|---|---|
| | efficiency to be greater | efficiency to be greater |
| Frequency | than 50% | than 40% |
| 900 MHz | 15 MHz | 22 MHz |
| 1800 MHz | 200 MHz | 230 MHz |

FIG. 3-9 is a top view of another terminal antenna. The terminal antenna is not provided with an antenna clearance area. An antenna support of the terminal antenna has a curved surface layer structure, and a size of the terminal antenna is 30 mm*4 mm*4 mm. The antenna support 200 of the terminal antenna is formed by stacking microwave dielectric ceramics (that is, a first material) and a plastic foam board (that is, a second material). A thickness ratio of the microwave dielectric ceramics to the plastic foam board is 1:3. A relative permittivity of the microwave dielectric ceramics is 40, and a relative permittivity of the plastic foam board is 1.07 to 1.1. In FIG. 3-9, 100 represents a grounding plate, and 300 represents an antenna radiation structure.

FIG. 3-10 is a side view of the terminal antenna shown in FIG. 3-9. In FIG. 3-10, 210 represents the microwave dielectric ceramics, 220 represents the plastic foam board, 100 represents the grounding plate, 300 represents the antenna radiation structure, and 400 represents a ground point. FIG. 3-11 is a curve diagram of efficiency and a band frequency of the terminal antenna 3110 and a terminal antenna 3111. In FIG. 3-11, a horizontal coordinate indicates the frequency, a unit is GHz, and a vertical coordinate indicates the efficiency. An antenna support of the terminal antenna 3111 is isotropic, and a relative permittivity of the material of the antenna support is 4.4. It can be learned from FIG. 3-11 that the terminal antenna 3110 provided in this embodiment of the present invention may implement efficiency greater than 50% within a frequency band of 3.8 GHz to 4.8 GHz, and a relative bandwidth is greater than 23%, that is, a ratio of a bandwidth that allows efficiency to be greater than 50% to a total bandwidth is greater than 23%. However, the terminal antenna 3111 cannot effectively radiate at a resonance frequency (the resonance frequency refers to a frequency at which the terminal antenna is in a resonance state), and the efficiency is not greater than 40%.

The antenna support in this embodiment of the present invention may also be structures, such as a columnar array structure, a hole-shaped array structure, or a ring array structure. The terminal antenna provided in this embodiment of the present invention is applicable to different frequency bands, such as a low frequency 900 MHz, a dual frequency (900 MHz and 1800 MHz), and a high frequency (such as 3500 MHz, 4500 MHz, or 4650 MHz).

Optionally, the antenna support may also be provided with a semiconductor particle, a conductor particle, or an insulator particle. A constitutive parameter of a material of the antenna support is adjusted by using the semiconductor particle, the conductor particle or the insulator particle.

In conclusion, according to the terminal antenna provided in the embodiments of the present invention, the antenna support of the terminal antenna has anisotropy, that is, components of the constitutive parameter of the antenna support in a specific direction are numerically different from those in any other direction. In this way, the electromagnetic wave can radiate in different directions, and the antenna support assists in radiation. Therefore, when the size of the terminal antenna is not increased, the bandwidth and efficiency of the terminal antenna can also meet a design requirement. Further, to reduce complexity of designing the terminal antenna, the grounding plate may not be provided with the antenna clearance area. At the same time, other metal components of a terminal can be disposed in the antenna support.

It should be noted that the size of the terminal antenna in the embodiments of the present invention refers to a size of a structure formed by the antenna support and the antenna radiation structure.

According to the terminal antenna provided in the embodiments of the present invention, compared with a terminal antenna having an isotropic antenna support, when the size is not increased, and the complexity of the terminal antenna is not increased, the terminal antenna has a larger bandwidth and higher efficiency. Further, the size of the terminal antenna may be reduced, and a small-sized terminal antenna of a one-eighth wavelength is implemented. In addition, when the antenna clearance area is reduced or even the antenna clearance area is not arranged, a larger bandwidth and higher efficiency are also achieved.

The terminal antenna provided in this embodiment of the present invention is applicable to different frequency bands.

The terminal antenna in this embodiment of the present invention may be a single-band planar inverted F antenna, a multi-band planar inverted F antenna, a monopole antenna, or a patch antenna. A type of the terminal antenna is not limited in the embodiments of the present invention.

An embodiment of the present invention further provides a terminal. The terminal includes an antenna system, and the antenna system includes the terminal antenna described in the foregoing embodiments.

Further, the antenna system further includes a printed circuit board (English: Printed Circuit Board, PCB for short) connected to the terminal antenna.

In conclusion, according to the terminal provided in the embodiments of the present invention, the terminal includes the antenna system. The antenna support of the terminal antenna included in the antenna system has anisotropy, that is, components of the constitutive parameter of the antenna support in a specific direction are different from those in any other direction. In this way, the electromagnetic wave can radiate in different directions, and the antenna support assists in radiation. Therefore, when the size of the terminal antenna is not increased, the bandwidth and efficiency of the terminal antenna can also meet the design requirement, thereby ensuring the communication quality of the terminal. Further, the size of the terminal antenna may be reduced, and when the size of the terminal is not increased, an arrangement requirement of the terminal antenna can be met, and a layout requirement of a component such as a battery or a radiant panel can also be met, thereby meeting a requirement of a user for using a small-sized terminal. In addition, the antenna clearance area may not be arranged, thereby reducing complexity of designing the terminal antenna, and further reducing complexity of designing the terminal.

The foregoing descriptions are merely optional embodiments of this application, but are not intended to limit this application. Any modification, equivalent replacement, or improvement made without departing from the spirit and principle of this application shall fall within the protection scope of this application.

What is claimed is:

1. A terminal antenna, wherein the terminal antenna comprises:
a grounding plate;
an antenna support; and
an antenna radiation structure,
wherein the grounding plate is connected to the antenna support;
wherein the antenna radiation structure is separately connected to the grounding plate and the antenna support; and
wherein the antenna support has anisotropy.

2. The terminal antenna according to claim 1, wherein the antenna support comprises at least two types of materials whose subwavelengths are periodically arranged, and the at least two types of materials have different constitutive parameters.

3. The terminal antenna according to claim 1, wherein the grounding plate is provided with an antenna clearance area.

4. The terminal antenna according to claim 2, wherein:
the antenna support has a planar layer structure, and the constitutive parameter is a relative permittivity;
the antenna support is formed by stacking two types of materials, and the two types of materials are arranged at intervals based on a subwavelength period; and
the two types of materials are a first material and a second material, wherein a thickness of the first material is not greater than a thickness of the second material, and a sum of the thickness of the first material and the thickness of the second material is less than a half of an electromagnetic wave wavelength corresponding to an operating frequency of the terminal antenna; and a relative permittivity of the first material is greater than a relative permittivity of the second material.

5. The terminal antenna according to claim 4, wherein a stacking direction of the first material and the second material is perpendicular to a height direction of the grounding plate.

6. The terminal antenna according to claim 4, wherein the grounding plate is not provided with an antenna clearance area.

7. The terminal antenna according to claim 6, wherein the antenna support is provided with a cavity, and the cavity is configured to dispose other metal components of a terminal.

8. The terminal antenna according to claim 6, wherein a stacking direction of the first material and the second material is parallel to a height direction of the grounding plate.

9. The terminal antenna according to claim 7, wherein a stacking direction of the first material and the second material is parallel to a height direction of the grounding plate.

10. The terminal antenna according to claim 4, wherein the relative permittivity of the first material is greater than or equal to 8, and the relative permittivity of the second material is 1 to 6.

11. The terminal antenna according to claim 10, wherein the relative permittivity of the second material is 1 to 4.

12. The terminal antenna according to claim 4, wherein the sum of the thickness of the first material and the thickness of the second material is less than one-fifth of the electromagnetic wave wavelength corresponding to the operating frequency of the terminal antenna.

13. The terminal antenna according to claim 1, wherein the antenna support is provided with a semiconductor particle, a conductor particle, or an insulator particle.

14. A terminal, wherein the terminal comprises an antenna system, and the antenna system comprises the terminal antenna according to claim 1.

15. The terminal according to claim 14, wherein the antenna system further comprises a printed circuit board (PCB) connected to the terminal antenna.
